(19) United States
(12) Patent Application Publication
(10) Pub. No.: US 2009/0152881 A1
(43) Pub. Date: Jun. 18, 2009

(54) BUMPER BEAM FOR VEHICLES

(75) Inventor: Yong Suk SHIN, Anyang-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/270,749

(22) Filed: Nov. 13, 2008

(30) Foreign Application Priority Data
Dec. 13, 2007 (KR) 10-2007-0130543

(51) Int. Cl. B60R 19/02

(52) U.S. Cl. 293/102

(57) ABSTRACT

A bumper beam provided in a bumper for vehicles is disclosed. The bumper beam of the present invention includes a vertical rib, which sections a space in the bumper beam into several spaces in a vertical direction, and horizontal ribs, which section the space in the bumper beam into several spaces in horizontal directions. The horizontal rib that is disposed behind the vertical rib is thicker than the horizontal rib that is disposed ahead of the vertical rib. Therefore, the bumper beam can impact energy in a consecutive impact absorbing manner.

### CROSS-REFERENCE TO RELATED APPLICATIONS

This application claims priority to Korean Application No. 10-2007-0130543, filed on Dec. 13, 2007, the disclosure of which is incorporated herein by reference.

### BACKGROUND OF THE INVENTION

(1) Field of the Invention

The present invention relates to a bumper beam provided in a bumper for vehicles to absorb impact force.

(2) Description of the Related Art

As is well known to those skilled in the art, bumpers having elastic impact absorbing ability are provided on vehicles to absorb and eliminate impact energy generated when a vehicle collision occurs. Such a bumper is provided on each of front and rear ends of a vehicle. The bumper includes a bumper cover, which determines the external appearance of each of the front and rear ends of the vehicle, and a bumper beam, which is provided inside the bumper cover to absorb external impact energy.

A conventional bumper beam includes a plurality of reinforcing ribs, which absorb impact energy using a structure such that it is deformed when external impact is applied thereto. The reinforcing ribs have the same thickness. Therefore, when external impact energy above a predetermined intensity is applied to the bumper beam, the bumper beam is crushed in an instant. In this case, the bumper beam cannot effectively absorb the impact energy.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, embodiments of the present invention provide a bumper beam for vehicles which absorbs impact energy, generated by the collision of a vehicle, in multiple steps, thus minimizing damage or injury to a driver and passengers attributable to the impact energy.

In order to accomplish the above object, a bumper beam provided in a bumper for vehicles, as an exemplary embodiment of the present invention, may include at least a vertical rib for sectioning a space in the bumper beam into a plurality of spaces in a vertical direction; and at least a horizontal rib for sectioning the space in the bumper beam into a plurality of spaces in horizontal directions, wherein the horizontal rib disposed behind the vertical rib, is thicker than the horizontal rib disposed ahead of the vertical rib, so that an impact energy is absorbed in a consecutive impact absorbing manner. A plurality of first impact absorbing spaces and a plurality of second impact absorbing spaces may be respectively defined ahead of and behind the vertical rib in the bumper beam, the first and second impact absorbing spaces being sectioned by the vertical and horizontal ribs, wherein number of the first impact absorbing spaces is greater than number of the second impact absorbing spaces. The bumper beam may be made of aluminum.

In another exemplary embodiment of the present invention, a bumper beam enclosed by a front surface, an upper surface, a lower surface, and a rear surface provided in a bumper for vehicles, may include: at least a vertical rib for sectioning a space in the bumper beam into at least two spaces in a vertical direction, wherein a plurality of impact absorbing parts are defined respectively therein; and at least a horizontal rib sectioning the plurality of impact absorbing parts respectively in horizontal direction, so that impact energy is absorbed at the impact absorbing parts in a consecutive impact absorbing manner.

The horizontal ribs in respective impact absorbing part may be distanced in equal intervals in vertical direction. Horizontal ribs in one impact absorbing part may not be on the same level with horizontal ribs in the other impact absorbing part respectively in horizontal direction.

The vertical ribs in respective impact absorbing part may be distanced in equal intervals in horizontal direction. Number of the horizontal ribs disposed ahead of vertical rib in a direction of facing an impact may be greater than number of the horizontal ribs disposed behind the vertical rib, wherein the horizontal ribs formed in the bumper frame may be configured to be arranged in a triangular shape, wherein horizontal rib in last impact absorbing part in a direction of facing impact may be configured to be a top of the triangular shape and horizontal rib in first impact absorbing part is configured to be a bottom of the triangular shape.

Number of the horizontal ribs in the last impact absorbing part in a direction of facing an impact may be one and positioned in the middle of the last impact absorbing part in vertical direction thereof wherein the horizontal ribs formed in the bumper frame are configured to be arranged in a triangular shape, wherein horizontal rib in the last impact absorbing part in a direction of facing impact is configured to be a top of the triangular shape and horizontal rib in first impact absorbing part is configured to be a bottom of the triangular shape. The horizontal ribs may be configured to be arranged in a triangular shape

The horizontal rib disposed behind a vertical rib, may be thicker than horizontal rib disposed ahead of the vertical rib wherein thickness of upper surface, horizontal rib, and lower surface in respective impact absorbing part is the same. Thickness of horizontal ribs in respective impact absorbing part may be the same.

Thickness of horizontal ribs in respective impact absorbing part may be the same

An impact absorbing space enclosed by the vertical rib and the horizontal rib may be shaped of rectangle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a bumper beam for vehicles, according to the present invention;

FIG. 2 is a sectional view taken along the line B-B of FIG. 1, according to an exemplary embodiment of the present invention; and

FIG. 3 is a sectional view taken along the line B-B of FIG. 1, according to another exemplary embodiment of the present invention.

In the figures, reference numbers refer to the same or equivalent parts of the present invention throughout the several figures of the drawing.

### DESCRIPTION OF THE PREFERRED EMBODIMENTS

Reference will now be made in detail to various embodiments of the present invention, examples of which are illustrated in the accompanying drawings and described below. While the invention will be described in conjunction with exemplary embodiments, it should be understood that the description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A bumper beam is provided in each of front and rear bumpers of a vehicle to absorb impact energy generated in a collision of the vehicle. The exemplary embodiments of the present invention will be explained on the basis of the bumper beam, which is provided in the front bumper of the vehicle.

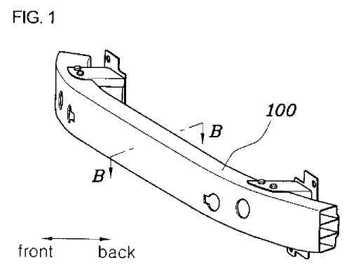

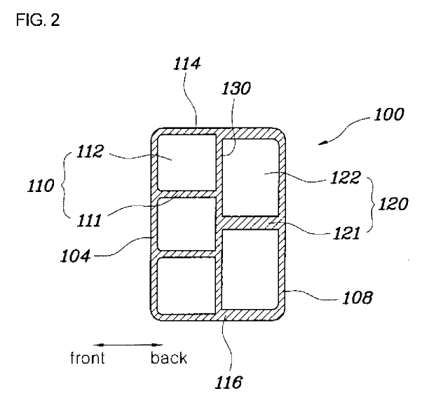

As shown in FIGS. 1 and 2, the bumper beam 100 having a closed shape in the cross-sectional view includes a front surface 104, a rear surface 108, a upper surface 114, a lower surface 116, a vertical rib, which sections the space in the bumper beam into several spaces in the vertical direction thereof, and horizontal ribs, which sections the inside space into several spaces in horizontal directions. The bumper beam 100 having the above-mentioned construction can absorb impact energy, generated in an external collision of the vehicle, in stages as explained in detail hereinafter.

In an exemplary embodiment of the present invention, as illustrated in FIG. 2, the bumper beam 100 has a structure in which a first impact absorbing part 110 and a second impact absorbing part 120, which are divided by the vertical rib 130 in the vertical direction, are arranged in sequence.

The first impact absorbing part 110 and the second impact absorbing part 120 are divided into several parts by first horizontal ribs 111 to form a plurality of first impact absorbing spaces 112 at the first impact absorbing part 100 and a second horizontal rib 121 to form a plurality of second impact absorbing spaces 122 at the second impact absorbing part 120 respectively, which are different in thickness from each other.

In the first impact absorbing part 110, a plurality of first impact absorbing spaces 112 is defined by at least a first horizontal rib 111. In the second impact absorbing part 120, a plurality of second impact absorbing spaces 122 is defined by at least a second horizontal rib 121. In an exemplary embodiment, the first impact absorbing part 110 comprises three first impact absorbing spaces 112, which are sectioned by the two first horizontal ribs 111 arranged parallel to each other respectively in the vertical direction. The second impact absorbing part 120 comprise two second impact absorbing spaces 122, which are sectioned by the one second horizontal rib 121.

Each of the first horizontal ribs 111, which are disposed at the front side of bumper beam 100, is thinner than the second horizontal rib 121, which is disposed at the rear side of the bumper beam 100. In other words, the second horizontal rib 121 has a thickness greater than that of each first horizontal rib 111. In another exemplary embodiment of the present invention, the upper surface 114 and the lower surface 116 at the second impact absorbing part 120 has the same thickness as that of the second horizontal rib 121.

From this configuration, when impact energy higher than a predetermined intensity is applied to the bumper beam 100, the first horizontal ribs 111, which are disposed at the front position, absorb the impact energy first, before the second horizontal rib 121, which is disposed at the rear position thereof, absorbs the impact energy. As such, the process of absorbing impact energy can be conducted in consecutive stages.

Here, the number of first impact absorbing spaces 112, which are defined at the front side in the bumper beam 100, may be greater than the number of second impact absorbing spaces 122, which are defined at the rear side in the bumper beam 100. This means that the number of first horizontal ribs 111 may be greater than the number of second horizontal rib 121.

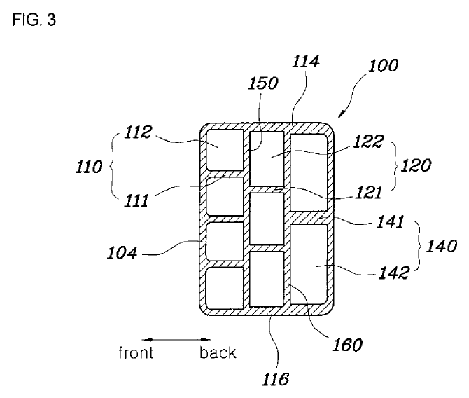

In another exemplary embodiment of the present invention, as shown in FIG. 3, a bumper beam 100 includes a first impact absorbing part 110, which has a plurality of first impact absorbing spaces 112, a second impact absorbing part 120, which has a plurality of second impact absorbing spaces 122, and a third impact absorbing part 140, which has a plurality of third impact absorbing spaces 142.

The first impact absorbing part 110, the second impact absorbing part 120 and the third impact absorbing part 140 are disposed in positional sequence from the front side to the rear side of the vehicle. A first vertical rib 150 is positioned between the first impact absorbing part 110 and the second impact absorbing part 120. A second vertical rib 160 is positioned between the second impact absorbing part 120 and the third impact absorbing part 140.

The first impact absorbing part 110 comprises four first impact absorbing spaces 112, which are sectioned by three first horizontal ribs 111 arranged in parallel to each other in the vertical direction. The second impact absorbing part 120 comprise three second impact absorbing spaces 122, which are sectioned by two second horizontal ribs 121. The third impact absorbing part 140 comprise two third impact absorbing spaces 142, which are sectioned by one third horizontal rib 141.

Each of the first horizontal ribs 111, which are disposed at the front side in the bumper beam 100, is thinner than each of the second horizontal ribs 121, which are disposed behind the first horizontal ribs 111. Each second horizontal rib 121 is thinner than the third horizontal rib 141, which is disposed behind the second horizontal rib 121. When impact energy greater than a predetermined intensity is applied to the bumper beam 100, the first horizontal ribs 111, the second horizontal ribs 121 and the third horizontal rib 141 consecutively absorb the impact energy in sequence from the thinnest to the thickest.

As such, impact energy is consecutively absorbed by the first impact absorbing part 110, the second impact absorbing part 120 and the third impact absorbing part 140 when it is applied to the vehicle. Therefore, the bumper beam 100 can effectively absorb impact energy.

As described above, in the present invention, when impact energy due to a collision of a vehicle is applied to a bumper beam of the vehicle, the bumper beam absorbs the impact energy in multiple stages, thus minimizing injury to a driver and passengers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A bumper beam provided in a bumper for vehicles, comprising:
at least a vertical rib for sectioning a space in the bumper beam into a plurality of spaces in a vertical direction; and
at least a horizontal rib for sectioning the space in the bumper beam into a plurality of spaces in horizontal directions, wherein the horizontal rib disposed behind the vertical rib, is thicker than the horizontal rib disposed ahead of the vertical rib, so that an impact energy is absorbed in a consecutive impact absorbing manner.

2. The bumper beam as set forth in claim 1, wherein a plurality of first impact absorbing spaces and a plurality of second impact absorbing spaces are respectively defined ahead of and behind the vertical rib in the bumper beam, the first and second impact absorbing spaces being sectioned by the vertical and horizontal ribs, wherein number of the first impact absorbing spaces is greater than number of the second impact absorbing spaces.

3. The bumper beam as set forth in claim 2, being made of aluminum.

4. A bumper beam enclosed by a front surface, an upper surface, a lower surface, and a rear surface provided in a bumper for vehicles, comprising:
at least a vertical rib for sectioning a space in the bumper beam into at least two spaces in a vertical direction, wherein a plurality of impact absorbing parts are defined respectively therein; and
at least a horizontal rib sectioning the plurality of impact absorbing parts respectively in horizontal direction, so that impact energy is absorbed at the impact absorbing parts in a consecutive impact absorbing manner.

5. The bumper beam as set forth in claim 4, wherein horizontal ribs in respective impact absorbing part are distanced in equal intervals in vertical direction

6. The bumper beam as set forth in claim 5, wherein horizontal ribs in one impact absorbing part is not on the same level with horizontal ribs in the other impact absorbing part respectively in horizontal direction.

7. The bumper beam as set forth in claim 4, wherein vertical ribs in respective impact absorbing part are distanced in equal intervals in horizontal direction.

8. The bumper beam as set forth in claim 4, wherein number of the horizontal ribs disposed ahead of vertical rib in a direction of facing an impact is greater than number of the horizontal ribs disposed behind the vertical rib.

9. The bumper beam as set forth in claim 8, wherein the horizontal ribs formed in the bumper frame are configured to be arranged in a triangular shape, wherein horizontal rib in last impact absorbing part in a direction of facing impact is configured to be a top of the triangular shape and horizontal rib in first impact absorbing part is configured to be a bottom of the triangular shape.

10. The bumper beam as set forth in claim 4, wherein number of the horizontal ribs in the last impact absorbing part in a direction of facing an impact is one and positioned in the middle of the last impact absorbing part in vertical direction thereof.

11. The bumper beam as set forth in claim 10, wherein the horizontal ribs formed in the bumper frame are configured to be arranged in a triangular shape, wherein horizontal rib in the last impact absorbing part in a direction of facing impact is configured to be a top of the triangular shape and horizontal rib in first impact absorbing pail is configured to be a bottom of the triangular shape.

12. The bumper beam as set forth in claim 11, wherein the horizontal ribs are configured to be arranged in a triangular shape

13. The bumper beam as set forth in claim 4, wherein horizontal rib disposed behind a vertical rib, is thicker than horizontal rib disposed ahead of the vertical rib.

14. The bumper beam as set forth in claim 13, wherein thickness of upper surface, horizontal rib, and lower surface in respective impact absorbing part is the same.

15. The bumper beam as set forth in claim 13, wherein thickness of horizontal ribs in respective impact absorbing part is the same

16. The bumper beam as set forth in claim 4, wherein thickness of horizontal ribs in respective impact absorbing part is the same

17. The bumper beam as set forth in claim 4, being made of aluminum.

18. The bumper beam as set forth in claim 4, wherein an impact absorbing space enclosed by the vertical rib and the horizontal rib is shaped of rectangle.
